(19) United States
(12) Patent Application Publication
(10) Pub. No.: US 2024/0211331 A1
(43) Pub. Date: Jun. 27, 2024

(54) SYSTEMS AND METHODS FOR A PROFILE-BASED MODEL SELECTOR

(71) Applicant: Capital One Services, LLC, McLean, VA (US)

(72) Inventors: Jeremy GOODSITT, Champaign, IL (US); Kenny BEAN, Herndon, VA (US); Austin WALTERS, Savoy, IL (US)

(73) Assignee: Capital One Services, LLC, McLean, VA (US)

(21) Appl. No.: 18/146,823

(22) Filed: Dec. 27, 2022

(51) Int. Cl. G06F 11/07; G06F 11/34

(52) U.S. Cl. CPC G06F 11/0766; G06F 11/3495

(57) ABSTRACT

Systems and methods for a profile-based model selector are described. In some aspects, the system receives an input dataset and a corresponding input data profile and determines a similarity metric for the input data profile with respect to each of a plurality of data profiles. Based on the similarity metric for the input data profile being highest with respect to a first data profile, the system processes the input dataset using a first model associated with the first data profile. Based on determining that performance of the first model when applied to the input dataset is above a threshold, the system verifies a separating hyperplane is placed such that the first data profile and the input data profile are included in a first profile domain and a second data profile is included in a second profile domain.

### SUMMARY

Data analytics have become more complex over time with new models developed every day to understand and predict results and properties of datasets. A side-effect of the increasing number of models is that it may become difficult to determine which data fits with which models. Certain models may only capture certain types of data properly. Selecting the wrong model for given input may lead to inaccurate results or even complete model failure. Conventional systems rely on pre-selectors to sort data into the correct models. However, this approach fails to anticipate that data that may appropriately fit with a given model at one point may drift over time, such that the model may be incompatible with the data after a particular point in time. Conventional systems therefore lack ways to dynamically re-normalize categorization of data with respect to the models in use, which means that these systems may not capture data drift until after failure occurs.

In some embodiments, to address one or more of the technical problems described above, methods and systems are described herein for executing a profile-based model selector configured to select a model for processing input data based on a corresponding data profile for the model. The system, after receiving the input data, may change the model to which the data is sent depending on past results. This process enables the system to determine whether incoming data is still consistent with a given model, as well as determine whether the model's performance with respect to the incoming data is changing. The system may then adjust the selection of models accordingly.

Conventionally, it is not possible to track whether incoming data becomes incompatible with a model due to, for example, data drift, before processing the incoming data through the model. The described system enables a comparison of a data profile associated with the received data to pre-determined criteria, defined by hyperplanes separating the various models in data profile space, in order to determine the model to which to send the data. Subsequently, depending on the performance of the data with respect to a given model, the system may adjust the criteria to improve reliability and accuracy for the model. Thus, the system enables input data to be sorted into piece-wise bins corresponding to each model based on data profiles associated with the data, allowing the system to dynamically improve the choice of model that the input data is sent to. In turn, the model may dynamically manage data drift or other changes to compatibility between input data and a given model. The effect of this management of data drift is improved efficiency in processing data, leading to fewer errors when passing data through models. The system accomplishes this by ensuring that data fits the model before any modeling of the input data actually occurs.

The system may receive an input dataset and a corresponding input data profile. For example, the system may receive a dataset, with a corresponding data profile that indicates, for example, the type of data represented in the dataset, a number of data entries, or a range of values within the data. The data profile may include meta-data relating to the input dataset, such as a time-stamp, a label, or a category of data. Data profiles may be determined through a variety of analytical algorithms that characterize, both quantitatively and qualitatively, the nature of the dataset. For example, a data profiler may calculate means, minimums, percentiles and frequencies relating to the data, and in some embodiments may calculate more advanced analytics, such as frequency distributions, key relationships, and functional dependencies. The resulting data profile may then contain information that serves to classify or characterize the data, as well as summarize it for more efficient future processing. By receiving both a dataset itself, as well as a data profile, the system gathers information that may assist in classifying the data in a way that allows for a determination of a satisfactory model to which to send the data.

The system may determine similarity metrics for the input data profile with respect to each of a plurality of data profiles. For example, the system may calculate a similarity metric by calculating a percentage of fields within the data profile that match each other. Individual fields that do not match perfectly may contribute to the similarity metric through algorithms (e.g., machine learning algorithms) that allow for fuzzy logic, where an engine may compare the data profiles and determine degrees of similarity of specific fields within the data profiles. For example, two datasets that have similar but not identical numbers of columns may return a relatively high percentage match, even if the number of columns within the respective data profiles do not match perfectly. A first data profile may be included within the plurality of data profiles, where this first data profile fits within a first profile domain that has performance above a threshold with respect to a first model. For example, data associated with a first data profile may have been passed through the first model, generating an output. The output may be compared to a reference dataset, such as a ground truth rather than a prediction. The system may then generate, based on the reference dataset and the output, a performance metric, that may be compared to a threshold performance. If the data corresponding to the first data profile indeed generates a performance metric above this value, the system may verify that the data profile is consistent with the first model and, therefore, sits within the first profile domain. A second data profile of the plurality of data profiles may be included in a second profile domain that has performance above a threshold with respect to a second model. A separating hyperplane may divide the first profile domain and the second profile domain. For example, the profile domain may define a set of ranges or allowed values of different fields within data profiles that are consistent with a given model (e.g., profiles that have been determined to generate acceptable performance metrics with respect to the given model). For example, a particular profile domain may include any data profiles with maximum values of between 5 and 10, and only datasets with integer-type data values. In some embodiments, these domain boundaries may be more complicated, and may be parametrized by boundaries that are dependent on multiple fields. For example, the boundary between two domains (e.g., the separating hyperplane) may have an equation of a line, plane or hyperplane in a vector space with respect to multiple data profile fields, which constitute dimensions in this vector space.

For example, the input data and corresponding data profile may contain audio files, with a particular length and bitrate. The system may determine that the input data has a high degree of similarity with another data profile that also refers to audio data with a similar length and bitrate, and this may be reflected in a relatively high similarity metric. On the other hand, the system may determine that the input audio file exhibits little similarity with a data profile relating to text documents and assign a relatively low similarity metric accordingly. By assigning similarity metrics between the input data profile and previously known data profiles, the system may match the input data with the closest data profile. As each of these previously known data profiles are already associated with high performance with respect to a particular model (e.g., these known data profiles may fit within a profile domain associated with a particular model separated by a separating hyperplane), the system may better match the input data to a satisfactory model.

Based on the similarity metric for the input data profile being highest with respect to the first data profile, the system may process the input dataset using the first model. For example, having determined that the data profile associated with the input data may have been most similar to a reference data profile of an audio recording, the system may then match the input data with a model that processes audio recordings. The system may determine the choice of model by determining the data profile domain in which the reference data profile sits and deducing the model corresponding to this data profile domain. As a result, the system may, based on the similarity metric, choose a model with which the input data may have the highest probability of success.

Based on determining the performance of the model applied to the input dataset, the system may verify the separating hyperplane or, alternatively, modify the separating hyperplane between the profile domains accordingly. That is, based on determining that performance of the second model when applied to the input dataset is above the threshold, the system may verify the separating hyperplane such that the first data profile and the input data profile are included in the first data profile domain, and the second data profile is included in the second profile domain. For example, the system may process the input dataset using the model, and determine that the model's performance with respect to the input dataset is satisfactory (e.g., above the threshold). Based on this determination, the system may validate that the input profile's data profile is represented within the first profile domain corresponding to the first model, and that the second model and corresponding profile domain are separated from the first profile domain by the hyperplane defining the boundary between the two models' profile domains. The system may do this by comparing the input data profile with the boundaries defined by the first profile domain and the second profile domain.

In some embodiments, the system may process the input dataset using the chosen model and determine that the first model's performance is not above the threshold with respect to the chosen model. In response to determining that the performance of the first model when applied to the input dataset is not above the threshold, the system may process the input dataset using the second model. In response to determining that the performance of the second model when applied to the input dataset is above the threshold, the system may modify the separating hyperplane such that the first data profile is included in the first profile domain and the second data profile and the input data profile are included in the second profile domain. For example, in response to determining that the first model does not produce satisfactory performance (e.g., a performance metric associated with the input data in the model does not reach a threshold), the system may subsequently process the input dataset with the second model instead. Upon determining that the performance of the second model with respect to the input dataset is, indeed, above the threshold, the system may then modify the separating hyperplane such that the second profile domain, corresponding to the second model, is modified to include the input data's profile as well. The system may accomplish this by modifying the boundaries of the profile domains mathematically (e.g., by modifying the equation of the corresponding line/plane/hyperplane). By doing so, the system may ensure that future datasets with similar data profiles are sorted into the same model, all while ensuring that any drift in the data that requires a modification in the chosen model is accounted for.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a.” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative environment for a profile-based model selector configured to select a model for processing a dataset, in accordance with one or more embodiments of this disclosure.

FIG. 2 shows an excerpt of a data structure for a data profile corresponding to a dataset, in accordance with one or more embodiments.

FIG. 3 shows an illustrative schematic for profile domains and corresponding separating hyperplanes, in accordance with one or more embodiments.

FIG. 4 shows an example of a process for determining and verifying profile domains with respect to an input data profile, in accordance with one or more embodiments.

FIG. 5 shows illustrative components for a system used alongside machine learning models, in accordance with one or more embodiments.

FIG. 6 shows a flowchart of operations for executing a profile-based model selector configured to select a model for processing a dataset based on a corresponding data profile, in accordance with one or more embodiments of this disclosure.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

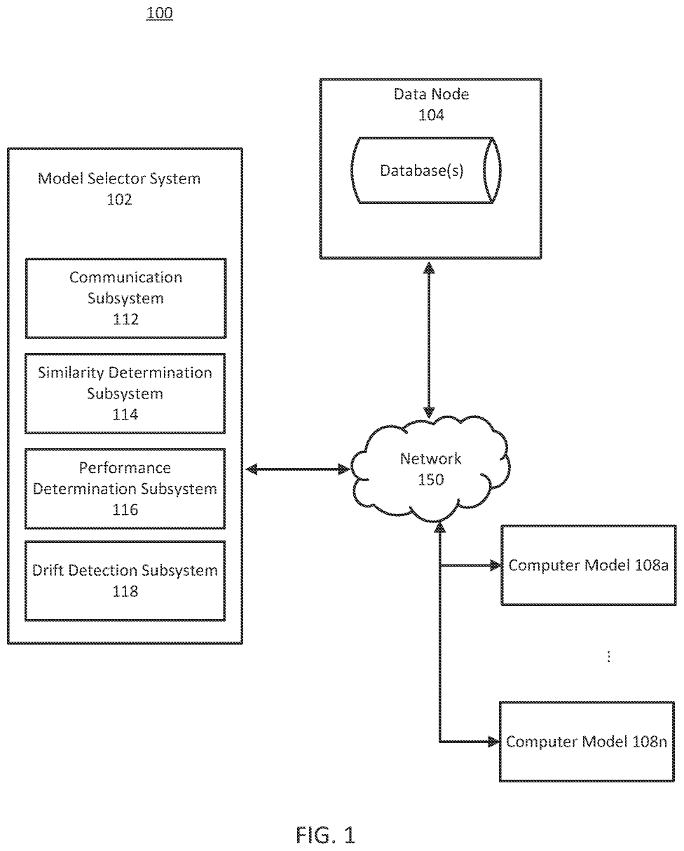

FIG. 1 shows an illustrative environment for a profile-based model selector configured to select a model for processing a dataset, in accordance with one or more embodiments of this disclosure. Environment 100 includes model selector system 102, data node 104, and computer models 108a-108n. Model selector system 102 may include software, hardware, or a combination of both and may reside on a physical server or a virtual server running on a physical computer system. In some embodiments, model selector system 102 may be configured on a user device (e.g., a laptop computer, a smart phone, a desktop computer, an electronic tablet, or another suitable user device). Furthermore, model selector system 102 may reside on a cloud-based system and/or interface with computer models either directly or indirectly, for example, through network 150. Model selector system 102 may include communication subsystem 112, similarity determination subsystem 114, performance determination subsystem 116, and/or drift detection subsystem 118.

Data node 104 may store various data, including one or more machine learning models, training data, data profiles, input data, output data, profile domain data, performance data, reference data and/or other suitable data. Data node 104 may include software, hardware, or a combination of the two. In some embodiments, model selector system 102 and data node 104 may reside on the same hardware and/or the same virtual server or computing device. Network 150 may be a local area network, a wide area network (e.g., the Internet), or a combination of the two.

Computer models 108a-108n may reside on client devices (e.g., desktop computers, laptops, electronic tablets, smartphones, servers, and/or other computing devices that enable data modeling). As referred to herein, computer models may include any algorithm or process that utilizes computation to simulate a model of a particular system. Computer models 108a-108n may include programs, scripts or algorithms that allow for processing data, for example to make predictions. Computer models 108a-108n may include discrete, continuous or mixed models, and may use algorithms such as machine learning, matrix decomposition or linear regression. Models may be stochastic or deterministic, steady-state or dynamic, or local or distributed. Machine learning models executed as part of computer models 108a-108n may utilize supervised or unsupervised learning, and may complete classification, regression or forecasting tasks. For example, a computer model may leverage artificial neural networks, linear regression, logistic regression, Bayes classification, K Means clustering, SVM (support vector machine) algorithms, natural language processing, natural language generation, decision trees, random forest algorithms, or K-nearest-neighbor algorithms. Because of the complexity of the type and nature of computer modeling that may be carried out, not all models may work well with all data input types. As a result, categorization of input data into corresponding models is necessary where satisfactory model performance is desirable. By leveraging data profiles, which serve to present input data in a more descriptive manner, environment 100 may better sort input data into corresponding computer models 108a-108n, such that model processing is more effective.

Model selector system 102 may receive input data from one or more devices. Model selector system 102 may receive data using communication subsystem 112, which may include software components, hardware components, or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as input data, input data profiles, or information about profile domains (e.g., sets of criteria). Communication subsystem 112 may communicate with similarity determination subsystem 114, performance determination subsystem 116 and drift detection subsystem 118.

In some embodiments, model selector system 102 may include similarity determination subsystem 114. Similarity determination subsystem 114 may perform tasks that determine degrees of similarity between types of data, such as input data, performance data or other types of data that are relevant to model selection. For example, similarity determination subsystem 114 may calculate similarity metrics by determining a measure of overlap between attributes in different data profiles, and assigning a metric based on the degree of overlap. Similarity determination subsystem 114 may include software components, hardware components, or a combination of both. For example, similarity determination subsystem 114 may include software components, or may include one or more hardware components (e.g., processors) that are able to execute operations for selecting models for processing datasets based on data profiles. Similarity determination subsystem 114 may access data, such as input data, data profiles, profile domains or separating hyperplanes, which may be stored, for example, in a memory system, or in data node 104 connected with network 150. Similarity determination subsystem 114 may directly access data or nodes associated with computer models 108a-108n and may transmit data to these computer models. Similarity determination subsystem 114 may, additionally or alternatively, receive data from and/or send data to communication subsystem 112, performance determination subsystem 116, or drift detection subsystem 118.

Performance determination subsystem 116 may execute tasks relating to determining the performance of computer models 108a-108n with respect to input data. Performance determination subsystem 116 may include software components, hardware components, or a combination of both. For example, in some embodiments, performance determination subsystem 116 may receive data output from a computer model (e.g., from any of models 108a-108n). Performance determination subsystem 116 may utilize one or more model evaluation techniques in order to determine the performance of a given model with respect to an input dataset, for example. Performance determination subsystem 116 may, for example, utilize techniques such as goodness-of-fit or goodness-of-prediction, and algorithms used to determine model performance may depend on the nature of the dataset. Performance determination subsystem 116 may receive input data, as well as data output by computer models 108a-108n. Performance determination subsystem 116 may access reference datasets, for example from data node 104 or database(s) within. Reference datasets may include information that reflects a ground truth as opposed to a model and, as such, may provide a basis for measuring model performance. Performance determination subsystem 116 allows model selector system 102 to determine a model's handling of an input dataset and, as such, allows the system to improve model selection, in accordance with one or more embodiments. Performance determination subsystem 116 may, additionally or alternatively, receive data from and/or send data to communication subsystem 112, similarity determination subsystem 114, or drift detection subsystem 118.

Drift detection subsystem 118 may execute tasks related to detecting shifts in profile domains for models. For example, drift detection subsystem 118 may determine whether an input data profile that initially performed well with respect to one model may actually perform better with respect to another model. Drift detection subsystem 118 may include software components (e.g., API calls), hardware components, or a combination of both. Drift detection subsystem 118 may, for example, receive information about model performance with respect to datasets from performance determination subsystem 116, or information about the similarity of data profiles from similarity determination subsystem 114. Drift detection subsystem 118 may also receive information from communication subsystem 112, such as input data, model outputs, and other information from data node 104 and computer models 108a-108n. By detecting drift in model selection rules, model selector system 102 may signal to administrators, for example, that the nature and behavior of data modelling is changing over time, which provides useful information for improving model efficacy and performance.

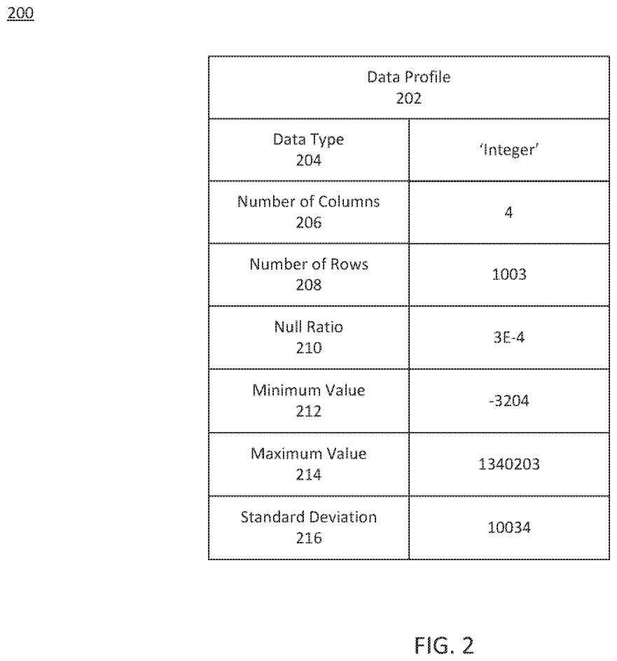

FIG. 2 shows an excerpt of a data structure for a data profile corresponding to a dataset, in accordance with one or more embodiments. Data structure 200 may store or represent a data profile, such as data profile 202, which may include one or more of fields 204-216 relating to a given dataset. For example, data profile 202 may include data type 204, number of columns 206, number of rows 208, null ratio 210, minimum value 212, maximum value 214 or standard deviation 216. Alternatively or additionally, data structure 200 may include any values or metadata regarding a dataset that may aid in model selection. Network 150 may supply the data profile, through or independent of communication subsystem 112, and the data profile may originate in data node 104 or any other location connected to network 150.

Model selector system 102 may receive an input dataset and corresponding input data profile. For example, model selector system 102 may receive this dataset from a database stored in data node 104 through communication subsystem 112. The input dataset may have a corresponding data profile 202, which provides information regarding the nature of the input dataset. In some embodiments, model selector system 102 may receive data profile 202 alongside the input dataset. In some embodiments, selector system 102 may generate or determine data profile 202 based on the input dataset. By receiving a data profile along with the input dataset, model selector system 102 may distill important information into the data profile in a manner that may aid in determining a suitable model choice for the input dataset. By utilizing data profiling, model selector system 102 may improve the efficiency and scalability of the model selection process. For example, computer models 108a-108n may not need to process entire datasets before determining if the given choice of model was satisfactory. Thus, including data profiles improves the ability of model selector system 102 to make decisions regarding model choice.

As referred to herein, a data profile may include a set of metadata or attributes related to a dataset. For example, as shown in FIG. 2, data profile 202 may include data type 204 as an attribute, which may aid in selection of models. For example, a model that is suited to integer arithmetic may be more suitable for an integer dataset, while a model that works on continuous data may be more compatible with float or double-type data. Data profile 202 may also include information about the shape or size of data. For example, data profile 202 may include the dataset's number of columns 206 or number of rows 208. Size or shape information may illuminate incompatibility between the dataset and a given model. For example, a given model may not be capable of efficiently handling longer, unstructured text data. Thus, any changes in model performance due to size or shape changes to data within input datasets may be considered and subsequently handled. Data profile 202 could include information about null ratios—as some computer models may struggle to handle null values, this information may provide a basis for excluding certain models from processing the given dataset if its null ratio is very high. Attributes within a data profile may include other analytical information, such as minimum or maximum values, or standard deviations (i.e., statistical information), which may be helpful for determining physical constraints to models. For example, a model that mathematically fits only positive values may not be suitably applied to an input dataset that contains a minimum value below 0. Data profiles may be considered as multidimensional vectors, wherein each component (e.g., a dimension) of the vector represents a separate attribute. By receiving both descriptive and analytical information relating to a dataset in the form of a data profile, model selector system 102 may improve the efficiency of making data processing decisions by considering the most important factors in the decision-making process.

Model selector system 102 may determine a similarity metric between the input data profile and each of multiple data profiles. That is, model selector system 102 may determine a similarity metric for the input data profile with respect to each of a plurality of data profiles. A first data profile of the plurality of data profiles may be included in a first profile domain having performance above a threshold with respect to a first model. A second data profile of the plurality of data profiles may be included in a second profile domain having performance above the threshold with respect to a second model. A separating hyperplane may divide the first profile domain and the second profile domain. For example, model selector system 102 may have access to information relating to other datasets with corresponding data profiles that have already been processed through computer models 108a-108n. Similarity determination subsystem 114 may access this data profile information through communication subsystem 112 and, thus, may compare the input dataset's data profile with these other data profiles, resulting with calculated similarity metrics between the input data profile and each of the other data profiles. Each of these other data profiles may have already been processed through models with suitable performance (e.g., a performance value or metric above a threshold performance value or metric). Thus, each of these data profiles may be associated with a computer model that produces satisfactory results.

As referred to herein, a similarity metric may refer to a measure of similarity between two data profiles associated with corresponding datasets. A similarity metric may provide information about to which two datasets are qualitative or quantitatively similar. In some embodiments, similarity determination subsystem 114 may involve determining a measure of overlap between attributes in the two data profiles. That is, similarity determination subsystem 114 may determine a measure of overlap between a plurality of attributes included in the input data profile and a corresponding plurality of attributes included in each of the plurality of data profiles. For example, a similarity metric may include a measure of overlap calculated from a percentage of attributes within two data profiles that match exactly. In some embodiments, a similarity metric from a measure of overlap may use fuzzy logic or consider the degree to which two attributes may match. Similarity determination subsystem 114 may calculate a similarity metric by taking an inner product between vectors representing respective data profiles or may be determined using supervised or unsupervised machine learning models, such as a k-nearest neighbor algorithm. Similarity determination subsystem 114 may, alternatively or additionally, use artificial neural networks for determining a similarity metric. By determining similarity metrics, model selector system 102 may objectively find a data profile to which the input data profile is most similar. Based on this selection, model selector system 102 may determine the computer model where this most similar data profile performs well (e.g., above a threshold performance) and may process the input dataset with this model. As a result, model selector system 102 may improve the likelihood of choosing a well-performing model for the input dataset, based on similarity with prior input datasets.

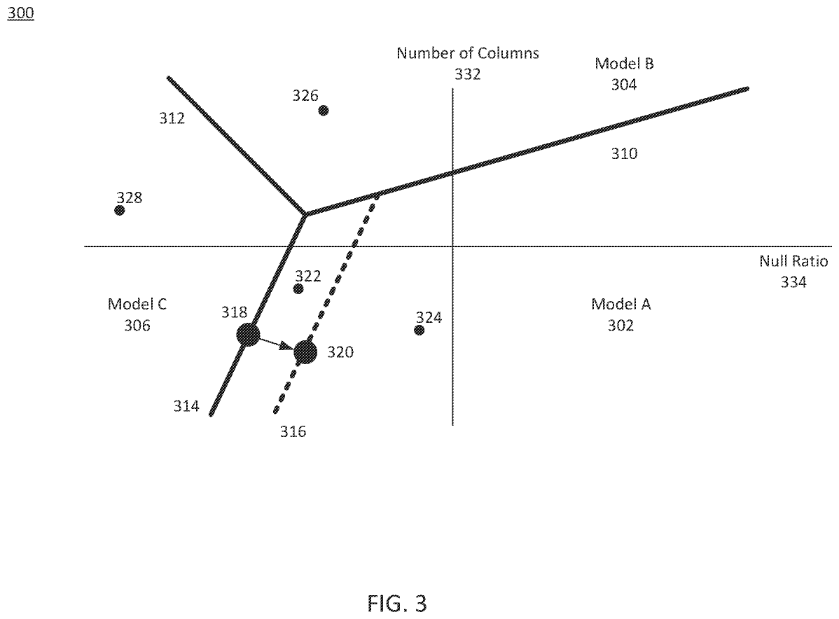

FIG. 3 shows an illustrative schematic for profile domains and corresponding separating hyperplanes, in accordance with one or more embodiments. Plot 300 maps profile domains corresponding to each of three models, Model A (corresponding to profile domain 302), Model B (corresponding to profile domain 304) and Model C (corresponding to 306) in a slice of profile domain space. Dimensions that are plotted are number of columns 332 and null ratio 334. Lines depict separating hyperplanes 310, 312 and 314 between three profile domains.

As referred to herein, a profile domain corresponding to a model may include sets of criteria that describes data profiles for data that, when processed, may be expected to perform above a threshold. For example, data profiles may be represented as vectors with dimensions corresponding to each attribute of the data profiles. A profile domain may represent a region in this multidimensional space where corresponding datasets are expected to exhibit satisfactory performance when processed by a given model, where the region is defined by a “set of criteria”.

FIG. 3 demonstrates profile domains for three models in a slice of 2D profile vector space, where two attributes represented as dimensions are number of columns 332 and null ratio 334. In this case, profile domain 302 corresponds to Model A, domain 304 corresponds to Model B and domain 306 corresponds to Model C. As referred to herein, a separating hyperplane may include a boundary in this vector space of domains separating the various profile domains.

For example, as shown, the space under separating hyperplanes 310 and 314 (depicted as lines in 2D) describes the vector space corresponding to domain 302. That is, data with a number of columns and a null ratio within this region of vector space may be likely to demonstrate suitable performance above a threshold with respect to Model A. Similarly, as depicted, data that has a number of columns and a null ratio within the region above separating hyperplanes 312 and 310 may be likely to exhibit performance above the threshold with processed with Model B. Subsequently, hyperplane 310 describes the separating hyperplane between Models A and B, for example. In some embodiments, the form of separating hyperplanes may be planes, or may have other shapes as defined in the vector space corresponding to profile domains. In some embodiments, a profile domain may be defined by ranges or particular labels of attributes; for example, Model D may perform well only with integer data with a number of columns above a certain value. By generalizing groups of data profiles that are likely consistent with particular models using profile domains, model selector system 102 may more efficiently choose a suitable model for input datasets without the need to process the full dataset first.

In some embodiments, profile domains associated with models may lack criteria relating to an attribute of the input data profile. Accordingly, model selector system 102 may update profile domains accordingly. That is, model selector system 102 may determine that an input attribute from a plurality of attributes included in the input data profile is not represented as a dimension in the first profile domain. Model selector system 102 may update the first profile domain and the second profile domain to include a new dimension representing the input attribute and may update the separating hyperplane to divide the first profile domain and the second profile domain with respect to the new dimension. For example, an input dataset may include a data profile with a “standard deviation” attribute, where the profile domains for models A-C may not have any indication of ranges or criteria of standard deviations consistent with the models. Model selector system 102 may then add this additional dimension, corresponding to the standard deviation attribute, to all of the relevant profile domains in order to consider this dimension. By doing so, model selector system 102 may adapt to new forms of data that the system receives, which allows for any drifts in forms of data to be dynamically accommodated.

In some embodiments, model selector system 102, through drift detection subsystem 118, for example, may determine that criteria for model choice is drifting and generate a warning based on this determination. That is, drift detection subsystem 118 may generate a drift parameter for a point on the separating hyperplane and, in response to determining that the drift parameter changed by more than a threshold drift value, generate a drift warning for display on a user interface associated with a first device. For example, drift detection subsystem 118 may parametrize a given hyperplane (e.g., hyperplane 314), for example, through the selection of point 318 on the hyperplane (i.e., a “drift parameter”). Model selector system 102 may cause separating hyperplane 314 to shift in the profile domain space, due to changes in data performance with respect to models A and C over time. As a result, separating hyperplane 314 may shift to a new position, at 316. As a result, parametrized point 318 may shift to point 320. If a distance associated with this shift is below a threshold drift value, the system may generate a warning that the model performance has changed. By tracking the drift parameter, drift detection subsystem 118 may allow administrators or other stakeholders to monitor for any drift in model performance and, if necessary, to tweak or improve the model accordingly.

As referred to herein, a drift parameter may include any value or parameter that may track a separating hyperplane's position. In some cases, the drift parameter may reflect a coordinate relating to a point on the separating hyperplane (e.g., points 318 or 320) in a vector space defined by the attributes of profile domains, for example. The drift parameter may also be another parameter associated with the separating hyperplane, such as an intercept with an axis or a hyperplane in space. In some embodiments, a drift parameter may reflect the upper or lower bounds of ranges of attributes that define profile domains. By following a parameter associated with the separating hyperplane, the system may track any large changes in performance of a model with respect to datasets. In response to such a change, drift detection subsystem 118, for example through communication subsystem 112, may transmit a drift warning to a user interface, in order to alert any necessary users of the change in model performance and enable the users to make any necessary modifications to the necessary models or input datasets. Thus, tracking the drift parameter allows for real-time monitoring of model performance in the system as a whole.

After determining a data profile with the highest similarity with the input data profile, model selector system 102 may process the input dataset using the model corresponding to that data profile. That is, based on the similarity metric for the input data profile being highest with respect to the first data profile, model selector system 102 may process the input dataset using the first model. After having determined a data profile closest to the input data profile, model selector system 102 may process the data with this data profile. By selecting a model that has already been determined to perform well with a similar dataset, model selector system 102 may minimize the risk of the input dataset being inconsistent with the selected model. Processing the input dataset with this model, then, enables model selector system 102 to either verify that the model performs adequately with the input dataset or determine that its performance is unsatisfactory and make corrective changes.

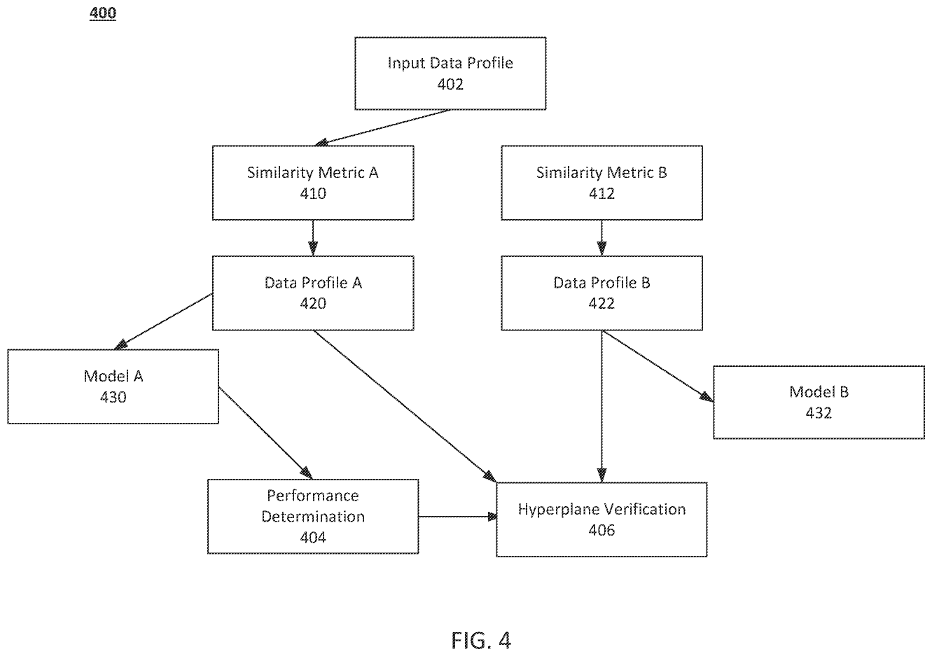

FIG. 4 illustrates flowchart 400 for determining and verifying profile domains with respect to an input data profile, in accordance with one or more embodiments. As described above, after receiving an input dataset and corresponding input data profile 402, model selector system 102 may determine that data profile A 420 has the highest similarity metric A 410 with the input data profile, compared to other data profiles, such as data profile B 422, with a lower similarity metric B 412 corresponding to model B 432. Having determined that data profile A has the highest similarity metric with respect to the input data profile, model selector system 102 may run the input dataset through model A (e.g., through one of models 108a-108n corresponding to model A). By processing the input dataset through model A 430, model selector system 102 may execute performance determination operation 404 for the model with respect to the input dataset and, as a result, may verify that the separating hyperplanes between adjacent profile domains associated with models is consistent with the performance of the input dataset (i.e., the system may carry out hyperplane verification 406), or may modify the hyperplane accordingly.

Model selector system 102 may, based on determining the performance of the model with respect to the input dataset, verify the separating hyperplane. That is, based on determining that performance of the first model when applied to the input dataset is above the threshold through performance determination subsystem 116, model selector system 102 may verify that the separating hyperplane is placed such that the first data profile and the input data profile are included in the first profile domain and the second data profile is included in the second profile domain. For example, after processing the input dataset through the first model, performance determination subsystem 116 may determine that the performance of the input dataset through the model is satisfactory (e.g., performance is above a threshold). For example, performance determination subsystem 116 may calculate a chi-squared value of the data with respect to real-world results and determine that the chi-squared value is below a particular, pre-determined value, which indicates that the model fits the real-world value adequately. After having made this determination, model selector system 102 may compare the input dataset's data profile with the profile domain corresponding to the first model and verify that the input dataset indeed fits and, thus, that the separating hyperplane is consistent with the performance of the respective models. For example, if the first model's profile domain is expressed as ranges of data profile attribute values (e.g., “sets of criteria”), model selector system 102 may verify that the attributes in the input data profile sit within the ranges of data profile attribute values. By doing so, model selector system 102 may ensure that any future data with similar data profiles may also be processed with the same model, as there is evidence that data similar to the input dataset may perform effectively enough.

In some embodiments, verifying the placement of a hyperplane separating two models is characterized by receiving criteria corresponding to the profile domains of the two models. Model selector system 102 may determine that attributes characterizing the first data profile and the input data profile satisfy the first model's criteria, but not the second model's criteria. That is, verifying the separating hyperplane is placed such that the first data profile and the input data profile are included in the first profile domain and the second profile domain is included in the second profile domain includes receiving, for the separating hyperplane, a first set of criteria for the first domain and a second set of criteria for the second profile domain, determining that a plurality of attributes for the first data profile and a plurality of attributes for the input data profile satisfy the first set of criteria and do not satisfy the second set of criteria, and determining that a plurality of attributes for the second data profile satisfy the second set of criteria and do not satisfy the first set of criteria. For example, model selector system 102 may determine a set of criteria defining profile domain 302 of a first model (e.g., model A in FIG. 3) as including all combinations of numbers of columns and null ratios below hyperplanes 310 and 314. Model selector system 102 may also determine a set of criteria defining profile domain 304 of a second model (e.g., model B in FIG. 3) as including all numbers of columns and null ratios above hyperplanes 310 and 312. Model selector system 102 may then verify that the input data profile has a number of columns and a null ratio consistent with model A's set of criteria, but not model B's set of criteria. Model selector system 102 may also verify that another data profile corresponding to model B is consistent with model B's set of criteria but not model A's criteria and, therefore, that the separating hyperplane is in the correct position and orientation. By verifying the sets of criteria corresponding to each model, model selector system 102 may dynamically confirm that incoming datasets are being sent to the correct models, and that no change in treatment of this received is required for proper model performance.

In some embodiments, determining the performance of the model (e.g., as in operation 404) when applied to the input dataset may include receiving an output dataset from processing the model, comparing the output dataset with a reference dataset, determining an error value and determining a performance metric from this error value. That is, determining that performance of the first model when applied to the input dataset is above the threshold may include receiving an output dataset from when the first model was applied to the input dataset, determining an error value based on comparing the output dataset with a reference dataset, and determining that a performance metric associated with the error value is above the threshold. For example, performance determination subsystem 116 may process the input dataset through the model that was determined to be associated with a data profile most similar to the input data profile. For example, the input dataset may be sent to any of computer models 108a-108n. In response, model selector system 102, for example, through communication subsystem 112, may receive an output dataset from the computer model. The output dataset may then be compared with a reference dataset, where an error value may be determined. For example, this error value may be a chi-squared value, calculated by, for example, comparing the squared error between the output dataset and the reference dataset normalized by the expected value at each data point. By determining an error value, performance determination subsystem 116 may evaluate the performance of the model with respect to real-world results and, thus, may dynamically evaluate the choice made by model selector system 102 for incoming input data.

As referred to herein, an “output dataset” may include results of a computer model or any other type of computation. For example, an output dataset may include predictions output from an artificial neural network model or may include the results of a linear regression based on the input dataset. In some embodiments, an output dataset may include language generated from a natural language generation algorithm, for example, or may include drawings or art output from an image analysis model. An output dataset may have many possible formats, such as tabulated or vectorized numbers or characters, illustrations, audio, video, graphs, charts, statistics, animations or waveforms. By evaluating this output data, performance determination subsystem 116 may determine whether model selection rules or criteria should be modified or not, which enables model selector system 102 to adapt to changes in model behavior with respect to input data.

As referred to herein, “performance” may refer to any qualitative or quantitative measure of the degree of functioning of a model. Performance may include whether a computer model runs without error messages or faults, or whether or not the model terminates by producing an output dataset. Performance may also include whether a computer model finishes efficiently, e.g., within a reasonable period of time, or without hogging too many computational resources. Performance may also include any measure of model accuracy, including whether the computer model produces bias, drifts in detection or data inconsistency. In some embodiments, performance may be quantitatively measured using a performance metric. Measures of performance, including performance metrics, may depend on the nature of the computer model being evaluated.

As referred to herein, a “threshold” may include any criteria for determining that model performance with respect to a dataset is satisfactory. These criteria may be quantitative or qualitative. For example, a threshold may include an assertion that a model must complete without errors for performance to be “above the threshold.” In some embodiments, a threshold may be quantitative; for example, the threshold may be represented by a value that a calculated performance metric must reach before model performance is deemed adequate. A threshold may be a value above which a performance metric must be for proper model function. However, in some embodiments, a threshold may be a maximum value, below which a performance metric must be for satisfactory performance (e.g., a maximum error value for an input dataset with respect to a reference dataset). As referred to herein, a model that has “satisfactory performance” with respect to a dataset may mean a model for which performance is above the threshold when applied to the dataset.

As referred to herein, a “reference dataset” may include any dataset that allows for evaluation of computer model output. For example, a reference dataset may include actual outcomes of values or data predicted by a computer model, such as thermometer data in relation to weather prediction output from a meteorological model for the same date, time and location. A reference dataset may include entries from training data, for example, that are used for training an artificial neural network. Model selector system 102 may store prior datasets and ground truth outcomes in a database (e.g., on data node 104), where output data may be compared with newly received input data. Reference datasets may have the same format as output data, such as tabulated or vectorized numbers or characters, illustrations, audio, video, graphs, charts, statistics, animations or waveforms. In some embodiments, reference datasets may be previously predicted outputs that have been validated or otherwise assumed to be accurate. For example, a collection of reference datasets may be created in real time as model performance is determined. In some embodiments, an input dataset's similarity to a reference dataset may be used to determine a model with which to process the input dataset. Comparing output data with a reference dataset enables performance determination subsystem 116 to provide a benchmark for output data in determining performance.

As referred to herein, a “performance metric” may include any quantitative measure of model performance. For example, a performance metric may be calculated by comparing an output dataset with a reference dataset to arrive at another statistical metric, such as error values. As referred to herein, an error value may refer to a statistical measure of model accuracy. Classification machine learning models, for example, may calculate, as error values, confusion matrices, type I or II errors, accuracy, recall/true positive rate or sensitivity, precision, specificity, F1 scores, Receiver Operating Characteristics Curve Area Under the Curve scores (ROC Curve-AUC score), or Prediction-Recall curves. Each of these metrics may highlight different types of errors, which may be important in different circumstances. For example, specificity may be important in applications where model predictions must be used to identify a particular class as opposed to those in a larger subset of possible classes for input data, while sensitivity may be more important if identifying the class itself is the more important objective. Similarly, regression-type models may utilize mean absolute error, mean squared error, root mean squared error or R-squared errors as statistical metrics. Performance determination subsystem 116 may then process statistical metrics or errors (e.g., normalize them, take the inverse or compare with other references) in order to arrive at a performance metric. A higher performance metric may indicate higher performance, and performance metrics may be comparable across datasets or applications. By calculating a performance metric from statistical errors, for example, performance determination subsystem 116 may present a universal, objective metric of model performance and compare this with, for example, a threshold performance metric, which enables multiple models to be compared and evaluated, even if models themselves are different. Thus, model selector system 102 may make more efficient and accurate model choice determinations independent of model type, for example.

In some embodiments, model selector system 102 may determine that no previously processed dataset has a data profile with enough similarity with the input data profile and, in response, may make a determination based on calculating a probability of failure. That is, based on determining that the similarity metric for the input data profile with respect to the first data profile is below a similarity threshold and that the similarity metric for the input data profile with respect to the second data profile is below the similarity threshold, model selector system 102 may determine a first probability of failure for applying the first model to the input data profile and a second probability of failure for applying the second model to the input data profile. Based on determining that the first probability of failure is lower than the second probability of failure, model selector system 102 may process the input dataset using the first model. For example, if model selector system 102 receives an input dataset that is very different (e.g., a similarity metric is too low for the input data profile with respect to any other previously encountered dataset's data profile), the system may determine a probability of failure for applying the input dataset to each model under consideration. Based on this probability of failure, model selector system 102 may redirect the input dataset to the model with the lowest probability of failure. Thus, even in the presence of insufficient prior information regarding model choice for a received input dataset, calculating a value for probability of failure enables model selector system 102 to make an educated, probability-based guess for a model with the lowest chance of model failure.

As referred to herein, a probability of failure may include a calculated value for a probability that a given model applied to a dataset will not have a performance above a threshold. For example, determining a probability of failure for received data may include generating a list of the most similar data profiles for data that has already been processed through the computer model, and determining a proportion of these similar data profiles that were successfully processed through the model (e.g., that had a performance metric above a threshold performance metric). A probability of failure may also be calculated through a machine learning model trained with prior model evaluation data. By calculating a probability of failure, model selector system 102 may improve decision-making for received datasets that are not well-characterized by previously processed datasets and corresponding profiles.

In some embodiments, the first model chosen by model selector system 102 may not have sufficient performance, and, in response, model selector system 102 may determine that a second model indeed has sufficient performance and modify the separating hyperplane such that the second model's profile domain encompasses the input data profile. That is, model selector system 102 may, based on determining that performance of the first model when applied to the input dataset is not above the threshold, process the input dataset using the second model. Model selector system 102 may, based on determining that performance of the second model when applied to the input dataset is above the threshold, modify the separating hyperplane such that the first data profile is included in the first profile domain and the second data profile and the input data profile are included in the second profile domain. For example, after determining that a first model (e.g., model A in FIG. 3) may have the best chance for processing the input dataset based on data profile similarity of data profile with attributes at point 322, performance determination subsystem 116 may find that the first model does not indeed achieve sufficient performance. In response, model selector system 102 may try another model (e.g., a model C in FIG. 3) and determine that this second model indeed does achieve performance above the threshold. Thus, model selector system 102 may modify the separating hyperplane that separates the first and second models (e.g., from hyperplane 314 to hyperplane 316) such that the second model's profile domain includes the input data profile (e.g., point 322), while verifying that data profile 328 remains associated with model C and data profile 324 remains associated with model A. By doing so, model selector system 102 may adapt and modify the decision-making process if its initial decision was not satisfactory (e.g., did not yield performance above the threshold). In doing so, the system may dynamically track any changes in model choice and, as such, may keep track of data drift in a way that enables more efficient processing of further data.

In some embodiments, both the first model and the second model may have performance above the threshold and, in response, model selector system 102 may modify profile domains such that future data similar to the input dataset is sent to the model with the higher performance. That is, model selector system 102 may determine that performance of the second model when applied to the input dataset is above the threshold and, based on determining that performance of the second model when applied to the input dataset is higher than performance of the first model when applied to the input dataset, model selector system 102 may modify the separating hyperplane such that the first data profile is included in the first profile domain and the second data profile and the input data profile are included in the second profile domain. For example, model selector system 102 may receive an input dataset with a profile at point 322 and, based on similarity metrics, may determine that model A is a suitable model choice for processing this data. However, performance determination subsystem 116 may determine that model C has higher performance with respect to data with a data profile at point 322 than model A. In response, model selector system 102 may modify the separating hyperplane that separates the first and second models (e.g., from hyperplane 314 to hyperplane 316) such that the second model's profile domain includes the input data profile (e.g., point 322), while verifying that data profile 328 remains associated with model C and data profile 324 remains associated with model A. By doing so, model selector system 102 may adapt and modify the decision-making process if performance with respect to another model is higher. In doing so, the system may dynamically track any changes in model choice and, as such, may optimize the choice of model with respect to model performance, even if performance is nominally satisfactory without making any changes.

In some embodiments, model selector system 102 may determine that neither of the models under consideration have satisfactory performance. In response, model selector system 102 may provide another model that does have performance above the threshold and add a profile domain and corresponding separating hyperplanes. That is, in response to determining that performance of the first model and performance of the second model when applied to the input dataset are both lower than the threshold, model selector system 102 may provide a third model with a third profile domain, wherein the third profile domain includes the input dataset. Model selector system 102 may generate a second separating hyperplane to divide the third profile domain and the first profile domain, generate a third separating hyperplane to divide the third profile domain and the second profile domain, and verify that the first separating hyperplane is such that the first data profile is included in the first profile domain and the second data profile is included in the second profile domain. For example, where model selector system 102 has only considered model A and model B for an input dataset corresponding to data profile 328, and where performance of model A and model B have both been determined to fall below the performance threshold with respect to the input dataset, model selector system 102 may add in model C that does attain the required performance threshold, and create separating hyperplanes 312 and 314 to separate the model C profile domain 306 from model A and model B profile domains (e.g., 302 and 304 respectively). Model selector system 102 may then verify that data profile 324 still corresponds to profile domain 302, data profile 326 still corresponds to profile domain 304, and data profile 328 (corresponding to the input dataset) is indeed associated with model C. In doing so, models may be added to model selector system 102 such that, in the presence of new input datasets that are not performing well with any current models, new models may be added to fill the gap in performance. Additionally, by solidifying the new model's profile domain and corresponding separating hyperplanes, any future data that arrives at model selector system 102 that is similar to data profile 328 may be classified into the new model. The system is then able to further refine profile domains and separating hyperplanes further.

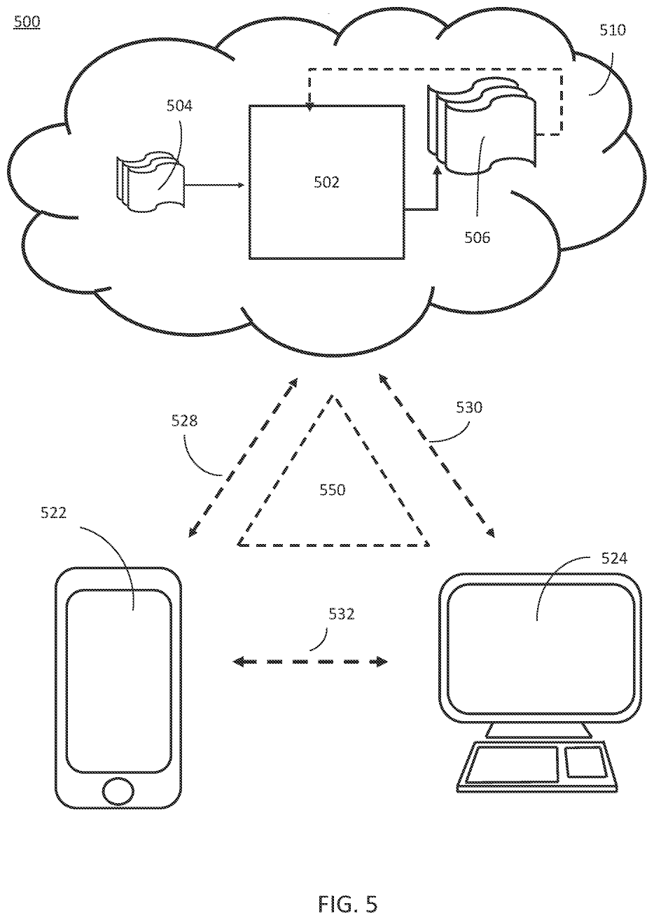

FIG. 5 shows illustrative components for a system used alongside machine learning models, in accordance with one or more embodiments. For example, FIG. 5 may show illustrative components for evaluating model selection through processing input datasets through machine learning models. As shown in FIG. 5, system 500 may include mobile device 522 and user terminal 524. While shown as a smartphone and personal computer, respectively, in FIG. 5, it should be noted that mobile device 522 and user terminal 524 may be any computing device, including, but not limited to, a laptop computer, a tablet computer, a hand-held computer, and other computer equipment (e.g., a server), including “smart,” wireless, wearable, and/or mobile devices. FIG. 5 also includes cloud components 510. Cloud components 510 may alternatively be any computing device as described above, and may include any type of mobile terminal, fixed terminal, or other device. For example, cloud components 510 may be implemented as a cloud computing system, and may feature one or more component devices. It should also be noted that system 500 is not limited to three devices. Users may, for instance, utilize one or more devices to interact with one another, one or more servers, or other components of system 500. It should be noted, that, while one or more operations are described herein as being performed by particular components of system 500, these operations may, in some embodiments, be performed by other components of system 500. As an example, while one or more operations are described herein as being performed by components of mobile device 522, these operations may, in some embodiments, be performed by components of cloud components 510. In some embodiments, the various computers and systems described herein may include one or more computing devices that are programmed to perform the described functions. Additionally, or alternatively, multiple users may interact with system 500 and/or one or more components of system 500. For example, in one embodiment, a first user and a second user may interact with system 500 using two different components.

With respect to the components of mobile device 522, user terminal 524, and cloud components 510, each of these devices may receive content and data via input/output (hereinafter “I/O”) paths. Each of these devices may also include processors and/or control circuitry to send and receive commands, requests, and other suitable data using the I/O paths. The control circuitry may include any suitable processing, storage, and/or input/output circuitry. Each of these devices may also include a user input interface and/or user output interface (e.g., a display) for use in receiving and displaying data. For example, as shown in FIG. 5, both mobile device 522 and user terminal 524 include a display upon which to display data (e.g., conversational response, queries, and/or notifications).

Additionally, as mobile device 522 and user terminal 524 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 500 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 5 also includes communication paths 528, 550, and 532. Communication paths 528, 530, and 532 may include the Internet, a mobile phone network, a mobile voice or data network (e.g., a 5G or LTE network), a cable network, a public switched telephone network, or other types of communications networks or combinations of communications networks. Communication paths 528, 530, and 532 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 510 may include model selector system 102, communication subsystem 112, similarity determination subsystem 114, performance determination subsystem 116, drift detection subsystem 118, data node 104 or computer models 108a-108n, and may be connected to network 150. Cloud components 510 may access model input and output datasets, as well as related data. For example, cloud components 510 may access data profiles (e.g., 202) and related attributes, such as data type 204, number of columns 20, number of rows 208, null ratio 210, minimum value 212, maximum value 214 and standard deviation 216. Cloud components 510 may access data relating to profile domains 302-306, such as sets of criteria, separating hyperplanes 310-314, or other data profiles 324-328.

Cloud components 510 may include model 502, which may be a machine learning model, artificial intelligence model, etc. (which may be referred collectively as “models” herein). Model 502 may take inputs 504 and provide outputs 506. The inputs may include multiple datasets, such as a training dataset and a test dataset. Each of the plurality of datasets (e.g., inputs 504) may include data subsets related to user data, predicted forecasts and/or errors, and/or actual forecasts and/or errors. In some embodiments, outputs 506 may be fed back to model 502 as input to train model 502 (e.g., alone or in conjunction with user indications of the accuracy of outputs 506, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an expectation of failure of applying a given model to a given dataset).

In a variety of embodiments, model 502 may update its configurations (e.g., weights, biases, or other parameters) based on the assessment of its prediction (e.g., outputs 506) and reference feedback information (e.g., user indication of accuracy, reference labels, or other information). In a variety of embodiments, where model 502 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 502 may be trained to generate better predictions.

In some embodiments, model 502 may include an artificial neural network. In such embodiments, model 502 may include an input layer and one or more hidden layers. Each neural unit of model 502 may be connected with many other neural units of model 502. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 502 may be self-learning and trained, rather than explicitly programmed, and can perform significantly better in certain areas of problem solving, as compared to traditional computer programs. During training, an output layer of model 502 may correspond to a classification of model 502, and an input known to correspond to that classification may be input into an input layer of model 502 during training. During testing, an input without a known classification may be input into the input layer, and a determined classification may be output.

In some embodiments, model 502 may include multiple layers (e.g., where a signal path traverses from front layers to back layers). In some embodiments, back propagation techniques may be utilized by model 502 where forward stimulation is used to reset weights on the “front” neural units. In some embodiments, stimulation and inhibition for model 502 may be more free-flowing, with connections interacting in a more chaotic and complex fashion. During testing, an output layer of model 502 may indicate whether or not a given input corresponds to a classification of model 502 (e.g., a categorization of an input dataset).

In some embodiments, the model (e.g., model 502) may automatically perform actions based on outputs 506. In some embodiments, the model (e.g., model 502) may not perform any actions. The output of the model (e.g., model 502) may be used to predict outcomes, perform regression, categorize input into classes, or for any other function for which a computer model may be used.

System 500 also includes API layer 550. API layer 550 may enable the system to generate summaries across different devices. In some embodiments, API layer 550 may be implemented on mobile device 522 or user terminal 524. Alternatively or additionally, API layer 550 may reside on one or more of cloud components 510. API layer 550 (which may be A REST or Web services API layer) may provide a decoupled interface to data and/or functionality of one or more applications. API layer 550 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 550 may use various architectural arrangements. For example, system 500 may be partially based on API layer 550, such that there is strong adoption of SOAP and RESTful Web-services, using resources like Service Repository and Developer Portal, but with low governance, standardization, and separation of concerns. Alternatively, system 500 may be fully based on API layer 550, such that separation of concerns between layers like API layer 550, services, and applications are in place.

In some embodiments, the system architecture may use a microservice approach. Such systems may use two types of layers: Front-End Layer and Back-End Layer where microservices reside. In this kind of architecture, the role of the API layer 550 may provide integration between Front-End and Back-End. In such cases, API layer 550 may use RESTful APIs (exposition to front-end or even communication between microservices). API layer 550 may use AMQP (e.g., Kafka, RabbitMQ, etc.). API layer 550 may use incipient usage of new communications protocols such as gRPC. Thrift, etc.

In some embodiments, the system architecture may use an open API approach. In such cases, API layer 550 may use commercial or open source API Platforms and their modules. API layer 550 may use a developer portal. API layer 550 may use strong security constraints applying WAF and DDOS protection, and API layer 550 may use RESTful APIs as standard for external integration.

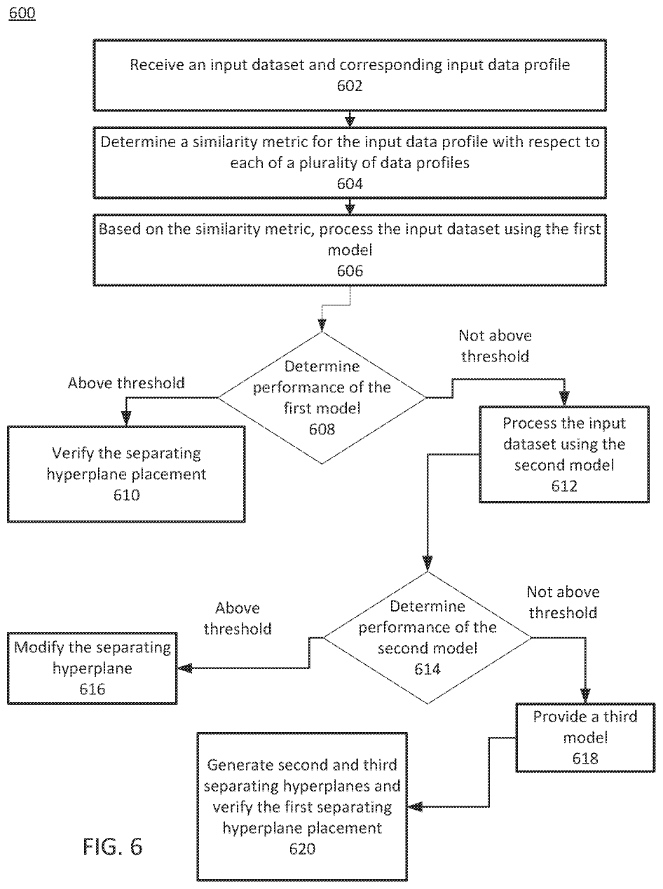

FIG. 6 shows a flowchart of the basic operations involved in executing a profile-based model selector configured to select a model for processing a dataset based on a corresponding data profile. For example, model selector system 102 may use process 600 (e.g., as implemented on one or more system components described above) in order to determine which model with which to process input datasets, based on other similar data profiles that were processed using models with satisfactory performance above a threshold.

At operation 602, process 600 (e.g., using one or more components described above) may enable model selector system 102 to receive an input dataset and corresponding input data profile. For example, communication subsystem 112, through a network interface, may receive an input dataset and corresponding input data profile at cloud components 510. Model selector system 102 may store the input dataset and input data profile in system memory, for example. The input data and input data profile may also be communicated to communication subsystem 112 and stored as inputs 504. Information included in the input data profile may include a plurality of attributes, such as data type 204, number of columns 206, number of rows 208, null ratio 210, minimum value 212, maximum value 214, or standard deviation 216. In some embodiments, data profile information and profile domain information may be stored in a vectorized form. Each dimension may represent, e.g., attributes or another suitable dimension.

At operation 604, process 600 (e.g., using one or more components described above) may enable model selector system 102 to determine a similarity metric for the input data profile with respect to each of a plurality of data profiles. For example, similarity determination subsystem 114, which may reside on cloud components 510, may determine a similarity metric for the input data profile with respect to each of a plurality of data profiles. By determining a similarity metric for the input dataset with respect to other models, similarity determination subsystem 114 searches for models that have satisfactorily processed prior data exhibiting a similar data profile to the input data profile. By doing so, model selector system 102 may improve the likelihood of successfully processing the input dataset, using prior information. A first data profile of the plurality of data profiles may be included in a first profile domain having performance above a threshold with respect to a first model. A second data profile of the plurality of data profiles may be included in a second profile domain having performance above the threshold with respect to a second model. A separating hyperplane may divide the first profile domain and the second profile domain. Profile domain information, including sets of criteria and hyperplanes separating the profile domains, may be stored in parametric form, for example, where parameters may mathematically define the hyperplanes in a vector space that maps to data profiles. Performance determination subsystem 116 may execute operations such that performance may be calculated (e.g., through a performance metric) and performance may be compared to a threshold value. Performance determination subsystem may, additionally or alternatively, access training data or reference data or previous outputs 506 from model 502.

At operation 606, process 600 (e.g., using one or more components described above) may enable model selector system 102, based on the similarity metric, to process the input dataset using the first model. For example, based on the similarity metric for the input data profile being highest with respect to the first data profile, cloud components 510 may process the input dataset as inputs 504 using the first model (e.g., as in model 502). In some embodiments, model selector system 102 may communicate inputs 504, through communication subsystem 112, to one or many of computer models 108a-108n that are connected to network 150. Model selector system 102 may receive outputs 506 from the one or many computer models through network 150 or may receive error messages or other communications from such a model. Model selector system 102 may store outputs 506 or these messages in cloud components 510, mobile device 522, user terminal 524, or any other device connected to network 150. By processing the input dataset using the first model, model selector system 102 may verify whether a model choice based on the input data profile's similarity with another data profile is enough to produce satisfactory performance above a threshold value. As a result, model selector system 102 may produce outputs (e.g., outputs 506) from passing the input dataset (e.g., inputs 504) through the chosen model (e.g., model 502), enabling further processing and evaluation of whether the model choice was satisfactory.

At operation 608, process 600 (e.g., using one or more components described above) may enable model selector system 102 to determine performance of the first model as applied to the input dataset through performance determination subsystem 116. For example, performance determination subsystem 116 may determine a performance metric, which may include any quantitative measure of model performance. For example, performance determination subsystem 116 may calculate a chi-squared error for outputs 506 derived from a linear regression model as applied to the input dataset by comparing to a reference dataset with previously acquired results (e.g., other outputs 506) and determine a performance metric based on this computer model error. Subsequently, performance determination subsystem 116 may determine whether the computer model operates with a performance above or below a threshold value. By doing so, model selector system 102 may evaluate the choice of model for compatibility with the input dataset and corresponding data profile, and may take action depending on whether or not the first model has satisfactory performance with respect to the input dataset.

At operation 610, process 600 (e.g., using one or more components described above) may enable model selector system 102, based on determining that performance of the first model is above the threshold, to verify the separating hyperplane placement. For example, model selector system 102 may verify the separating hyperplane (e.g., parameters of the hyperplane) is placed such that the first data profile and the input dataset are included in the first profile domain, and the second data is included in the second profile domain. Model selector system 102 may access information regarding profile domains of the first and second model, such as “sets of criteria” (e.g., ranges of values for data profile attributes that correspond to a given model), from system memory corresponding to cloud components 510, mobile device 522, or user terminal 524, for example. The separating hyperplane separating the profile domains for the first and second models may be parametrized mathematically, or may involve Boolean or logic operators for each attribute. Processors attached to cloud components 510 may evaluate the input data profile's attributes for consistency with the separating hyperplane and corresponding profile domain for the first model (e.g., model 502) and may ensure that the input dataset (e.g., inputs 504) is included within these criteria. As such, model selector system 102 may enable future data with similar data profiles to be sorted into a similar model, having already verified that similar data (i.e., the input dataset) is consistent with the model.

At operation 612, process 600 (e.g., using one or more components described above) may enable model selector system 102, based on determining that performance of the first model is not above the threshold, to process the input dataset using the second model. That is, model selector system 102 may, for example, utilize processors within cloud components 510 to process the input dataset using the second model (e.g., by setting the second model as model 502 and the input dataset as inputs 504), in response to determining that performance of the first model when applied to the input dataset is not above the threshold. For example, if model performance of the first model was not satisfactory, model selector system 102 may attempt to match the input dataset with a second model and determine whether its performance is satisfactory. In some embodiments, the choice of second model may also be influenced by a similarity metric calculated in operation 606 (e.g., a model corresponding to the data profile with the second highest similarity metric with respect to the input data profile may be chosen as the second model). By doing so, model selector system 102 incorporates resilience with respect to unsatisfactory model performance, and allows model selector system 102 to attempt other avenues for achieving the performance threshold required. In response to model results (e.g., outputs 506), model selector system 102 may learn from the performance of the input dataset with respect to this second model and, as such, may make further determinations and modifications of the relevant profile domains, to improve treatment of future datasets.

At operation 614, process 600 (e.g., using one or more components described above) may enable model selector system 102 to determine performance of the second model. That is, model selector system 102, through performance determination subsystem 116 within cloud components 510, may determine the performance of the second model when applied to the input dataset. Like in operation 608, performance determination subsystem 116 may determine, for example, a performance metric or another measure of performance of the second model with respect to the input dataset. Performance data may also include qualitative data, such as whether the model performed efficiently or produced the correct output data type. Thus, this performance determination for the second model provides model selector system 102 more information regarding model compatibility with respect to the input dataset and enables model selector system 102 to provide improved recommendations for future input datasets.

At operation 616, process 600 (e.g., using one or more components described above) may enable model selector system 102 to, based on determining that performance of the second model is above the threshold, modify the separating hyperplane. For example, model selector system 102, using cloud components 510, may extract information about the separating hyperplane between profile domains corresponding to the first and second models from a system memory and modify this separating hyperplane such that the input dataset is included in the second model's profile domain. For example, model selector system 102 may determine parameters corresponding to the separating hyperplane's defining equation and modify these parameters such that the input dataset's data profile vector representation fits on the side of the separating hyperplane corresponding to the second model's profile domain. For example, model selector system 102 may, using processors within cloud components 510, modify separating hyperplane 314 between a first model (model A, with profile domain 302) and a second model (model C, with profile domain 306) such that the input dataset's data profile at point 322 sits within the second model's profile domain. This modification may involve, for example, shifting separating hyperplane 314 to position 316. In some embodiments, modifying the separating hyperplane may include twisting the hyperplane, translating the hyperplane, or adding one or more dimensions to the representational vector space of data profiles. By modifying the separating hyperplane, model selector system 102 may commit to memory clues as to how to deal with future input data that is similar to the current input dataset with respect to data profiles, enabling the system to learn from unsatisfactory model performance for the first model.

At operation 618, process 600 (e.g., using one or more components described above) may enable model selector system 102 to, based on determining that performance of the first and second models is not above the threshold, provide a third model. That is, model selector system 102 may, in response to determining that performance of the first model (e.g., operation 608) and performance of the second model (e.g., operation 614) when applied to the input dataset are both lower than the threshold, provide a third model with a third profile domain, where the third profile domain includes the input dataset. For example, performance determination subsystem 116 may have determined that no previously known model, for whom data profiles matched the input dataset, was able to exhibit performance to a suitable threshold. In response, model selector system 102 may provide a new model that is compatible with the input dataset (e.g., by modifying existing models, or by interfacing with network 150 or with other devices within cloud components 510, mobile device 522 or user terminal 524).

At operation 620, in response to finding this third model, model selector system 102 may modify the vector space representation of the data profiles to add this third model, as well as a profile domain corresponding to this third model that includes the well-performing input dataset. That is, model selector system 102 may generate a second separating hyperplane to divide the third profile domain and the first profile domain, generate a third separating hyperplane to divide the third profile domain and the second profile domain, and verify that the first separating hyperplane is such that the first data profile is included in the first profile domain and the second data profile is included in the second profile domain. For example, model selector system 102 may add model B to the system where only model A and model C existed prior. Model selector system 102 may then add separating hyperplane 310 to separate between model A's profile domain 302 and model B's profile domain 304. Model selector system 102 may add separating hyperplane 312 to separate between model C's profile domain 306 and profile domain 304. By doing so, model selector system 102 may improve the choice of model within the system and, as a result, improve the robustness of the system at dealing with further input data that is similar to the current input dataset. By relying on data profiles, model selector system 102 may improve the system processing of large datasets and may reduce the amount of trial-and-error required for determining model choice upon receiving new datasets.

It is contemplated that the operations or descriptions of FIG. 6 may be used with any other embodiment of this disclosure. In addition, the operations and descriptions described in relation to FIG. 6 may be done in alternative orders or in parallel to further the purposes of this disclosure. For example, each of these operations may be performed in any order, in parallel, or simultaneously to reduce lag or increase the speed of the system or method. Furthermore, it should be noted that any of the components, devices, or equipment discussed in relation to the figures above could be used to perform one or more of the operations in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques for executing a profile-based model selector configured to select a model for processing a dataset based on a corresponding data profile will be better understood with reference to the following enumerated embodiments:

1. A method, comprising: determining an input data profile for an input dataset, wherein the input data profile comprises a plurality of attributes for the input dataset; determining a similarity metric for the input data profile with respect to each of a plurality of data profiles, wherein: a first data profile of the plurality of data profiles is included in a first profile domain having performance above a threshold with respect to a first model, a second data profile of the plurality of data profiles is included in a second profile domain having performance above the threshold with respect to a second model, and a separating hyperplane divides the first profile domain and the second profile domain; in response to the similarity metric for the input data profile being highest with respect to the first data profile, processing the input dataset using the first model; in response to determining that performance of the first model when applied to the input dataset is not above the threshold, processing the input dataset using the second model; and in response to determining that performance of the second model when applied to the input dataset is above the threshold, modifying the separating hyperplane such that the first data profile is included in the first profile domain and the second data profile and the input data profile are included in the second profile domain.
2. A method, comprising: receiving an input dataset and a corresponding input data profile; determining a similarity metric for the input data profile with respect to each of a plurality of data profiles, wherein: a first data profile of the plurality of data profiles is included in a first profile domain having performance above a threshold with respect to a first model, a second data profile of the plurality of data profiles is included in a second profile domain having performance above the threshold with respect to a second model, and a separating hyperplane divides the first profile domain and the second profile domain; based on the similarity metric for the input data profile being highest with respect to the first data profile, processing the input dataset using the first model; based on determining that performance of the first model when applied to the input dataset is not above the threshold, processing the input dataset using the second model; and based on determining that performance of the second model when applied to the input dataset is above the threshold, modifying the separating hyperplane such that the first data profile is included in the first profile domain and the second data profile and the input data profile are included in the second profile domain.
3. A method, comprising: receiving an input dataset and a corresponding input data profile; determining a similarity metric for the input data profile with respect to each of a plurality of data profiles, wherein: a first data profile of the plurality of data profiles is included in a first profile domain having performance above a threshold with respect to a first model, a second data profile of the plurality of data profiles is included in a second profile domain having performance above the threshold with respect to a second model, and a separating hyperplane divides the first profile domain and the second profile domain; based on the similarity metric for the input data profile being highest with respect to the first data profile, processing the input dataset using the first model; and based on determining that performance of the first model when applied to the input dataset is above the threshold, verifying the separating hyperplane is placed such that the first data profile and the input data profile are included in the first profile domain and the second data profile is included in the second profile domain.
4. The method of any one of the preceding embodiments, further comprising: based on determining that performance of the first model when applied to the input dataset is not above the threshold, processing the input dataset using the second model; and based on determining that performance of the second model when applied to the input dataset is above the threshold, modifying the separating hyperplane such that the first data profile is included in the first profile domain and the second data profile and the input data profile are included in the second profile domain.
5. The method of any one of the preceding embodiments, further comprising: determining that an input attribute from a plurality of attributes included in the input data profile is not represented as a dimension in the first profile domain; updating the first profile domain and the second profile domain to include a new dimension representing the input attribute; and updating the separating hyperplane to divide the first profile domain and the second profile domain with respect to the new dimension.
6. The method of any one of the preceding embodiments, wherein determining the similarity metric for the input data profile with respect to each of the plurality of data profiles comprises: determining a measure of overlap between a plurality of attributes included in the input data profile and a corresponding plurality of attributes included in each of the plurality of data profiles.
7. The method of any one of the preceding embodiments, wherein verifying the separating hyperplane is placed such that the first data profile and the input data profile are included in the first profile domain and the second data profile is included in the second profile domain comprises: receiving, for the separating hyperplane, a first set of criteria for the first profile domain and a second set of criteria for the second profile domain; determining that a plurality of attributes for the first data profile and a plurality of attributes for the input data profile satisfy the first set of criteria and do not satisfy the second set of criteria; and determining that a plurality of attributes for the second data profile satisfy the second set of criteria and do not satisfy the first set of criteria.
8. The method of any one of the preceding embodiments, wherein determining that performance of the first model when applied to the input dataset is above the threshold comprises: receiving an output dataset from when the first model was applied to the input dataset; based on comparing the output dataset with a reference dataset, determining an error value; and determining that a performance metric associated with the error value is above the threshold.
9. The method of any one of the preceding embodiments, further comprising: based on determining that the similarity metric for the input data profile with respect to the first data profile is below a similarity threshold and that the similarity metric for the input data profile with respect to the second data profile is below the similarity threshold, determining a first probability of failure for applying the first model to the input data profile and a second probability of failure for applying the second model to the input data profile; and based on determining that the first probability of failure is lower than the second probability of failure, processing the input dataset using the first model.
10. The method of any one of the preceding embodiments, further comprising: determining that performance of the second model when applied to the input dataset is above the threshold; and based on determining that performance of the second model when applied to the input dataset is higher than performance of the first model when applied to the input dataset, modifying the separating hyperplane such that the first data profile is included in the first profile domain and the second data profile and the input data profile are included in the second profile domain.
11. The method of any one of the preceding embodiments, further comprising: in response to determining that performance of the first model and performance of the second model when applied to the input dataset are both lower than the threshold, providing a third model with a third profile domain, wherein the third profile domain includes the input dataset; and generating a second separating hyperplane to divide the third profile domain and the first profile domain, generating a third separating hyperplane to divide the third profile domain and the second profile domain, and verifying that the first separating hyperplane is such that the first data profile is included in the first profile domain and the second data profile is included in the second profile domain.
12. The method of any one of the preceding embodiments, further comprising: generating a drift parameter for a point on the separating hyperplane; and in response to determining that the drift parameter changed by more than a threshold drift value, generating a drift warning for display on a user interface associated with a first device.
13. A tangible, non-transitory, machine-readable medium storing instructions that, when executed by a data processing apparatus, cause the data processing apparatus to perform operations comprising those of any embodiments 1-12.
14. A system comprising one or more processors; and memory storing instructions that, when executed by the processors, cause the processors to effectuate operations comprising those of any of embodiments 3-12.
15. A system comprising means for performing any of embodiments 1-12.
16. A system comprising cloud-based circuitry for performing any of embodiments 1-12.

What is claimed is:

1. A system for executing a profile-based model selector configured to select a model for processing a dataset based on a corresponding data profile, comprising:
one or more processors; and
a non-transitory, computer-readable medium comprising instructions that when executed by the one or more processors cause operations comprising:
determining an input data profile for an input dataset, wherein the input data profile comprises a plurality of attributes for the input dataset;
determining a similarity metric for the input data profile with respect to each of a plurality of data profiles, wherein:
a first data profile of the plurality of data profiles is included in a first profile domain having performance above a threshold with respect to a first model,
a second data profile of the plurality of data profiles is included in a second profile domain having performance above the threshold with respect to a second model, and
a separating hyperplane divides the first profile domain and the second profile domain;
in response to the similarity metric for the input data profile being highest with respect to the first data profile, processing the input dataset using the first model;
in response to determining that performance of the first model when applied to the input dataset is not above the threshold, processing the input dataset using the second model; and
in response to determining that performance of the second model when applied to the input dataset is above the threshold, modifying the separating hyperplane such that the first data profile is included in the first profile domain and the second data profile and the input data profile are included in the second profile domain.

2. A method, comprising:
receiving an input dataset and an input data profile corresponding to the input dataset;
determining a similarity metric for the input data profile with respect to each of a plurality of data profiles, wherein:
a first data profile of the plurality of data profiles is included in a first profile domain having performance above a threshold with respect to a first model,
a second data profile of the plurality of data profiles is included in a second profile domain having performance above the threshold with respect to a second model, and
a separating hyperplane divides the first profile domain and the second profile domain;
based on the similarity metric for the input data profile being highest with respect to the first data profile, processing the input dataset using the first model; and
based on determining that performance of the first model when applied to the input dataset is above the threshold, verifying the separating hyperplane is placed such that the first data profile and the input data profile are included in the first profile domain and the second data profile is included in the second profile domain.

3. The method of claim 2, further comprising:
based on determining that performance of the first model when applied to the input dataset is not above the threshold, processing the input dataset using the second model; and
based on determining that performance of the second model when applied to the input dataset is above the threshold, modifying the separating hyperplane such that the first data profile is included in the first profile domain and the second data profile and the input data profile are included in the second profile domain.

4. The method of claim 2, further comprising:
determining that an input attribute from a plurality of attributes included in the input data profile is not represented as a dimension in the first profile domain;
updating the first profile domain and the second profile domain to include a new dimension representing the input attribute; and
updating the separating hyperplane to divide the first profile domain and the second profile domain with respect to the new dimension.

5. The method of claim 2, wherein determining the similarity metric for the input data profile with respect to each of the plurality of data profiles comprises:
determining a measure of overlap between a plurality of attributes included in the input data profile and a corresponding plurality of attributes included in each of the plurality of data profiles.

6. The method of claim 2, wherein verifying the separating hyperplane is placed such that the first data profile and the input data profile are included in the first profile domain and the second data profile is included in the second profile domain comprises:
receiving, for the separating hyperplane, a first set of criteria for the first profile domain and a second set of criteria for the second profile domain;
determining that a plurality of attributes for the first data profile and a plurality of attributes for the input data profile satisfy the first set of criteria and do not satisfy the second set of criteria; and
determining that a plurality of attributes for the second data profile satisfy the second set of criteria and do not satisfy the first set of criteria.

7. The method of claim 2, wherein determining that performance of the first model when applied to the input dataset is above the threshold comprises:
receiving an output dataset from when the first model was applied to the input dataset;
based on comparing the output dataset with a reference dataset, determining an error value; and
determining that a performance metric associated with the error value is above the threshold.

8. The method of claim 2, further comprising:
based on determining that the similarity metric for the input data profile with respect to the first data profile is below a similarity threshold and that the similarity metric for the input data profile with respect to the second data profile is below the similarity threshold, determining a first probability of failure for applying the first model to the input data profile and a second probability of failure for applying the second model to the input data profile; and
based on determining that the first probability of failure is lower than the second probability of failure, processing the input dataset using the first model.

9. The method of claim 2, further comprising:
determining that performance of the second model when applied to the input dataset is above the threshold; and
based on determining that performance of the second model when applied to the input dataset is higher than performance of the first model when applied to the input dataset, modifying the separating hyperplane such that the first data profile is included in the first profile domain and the second data profile and the input data profile are included in the second profile domain.

10. The method of claim 2, further comprising:
in response to determining that performance of the first model and performance of the second model when applied to the input dataset are both lower than the threshold, providing a third model with a third profile domain, wherein the third profile domain includes the input dataset; and
generating a second separating hyperplane to divide the third profile domain and the first profile domain, generating a third separating hyperplane to divide the third profile domain and the second profile domain, and verifying that the separating hyperplane is such that the first data profile is included in the first profile domain and the second data profile is included in the second profile domain.

11. The method of claim 2, further comprising:
generating a drift parameter for a point on the separating hyperplane; and
in response to determining that the drift parameter changed by more than a threshold drift value, generating a drift warning for display on a user interface associated with a first device.

12. A non-transitory, computer-readable medium comprising instructions that when executed by one or more processors cause operations comprising:
receiving an input dataset and an input data profile corresponding to the input dataset;
determining a similarity metric for the input data profile with respect to each of a plurality of data profiles, wherein:
a first data profile of the plurality of data profiles is included in a first profile domain having performance above a threshold with respect to a first model,
a second data profile of the plurality of data profiles is included in a second profile domain having performance above the threshold with respect to a second model, and
a separating hyperplane divides the first profile domain and the second profile domain;
based on the similarity metric for the input data profile being highest with respect to the first data profile, processing the input dataset using the first model;
based on determining that performance of the first model when applied to the input dataset is not above the threshold, processing the input dataset using the second model; and
based on determining that performance of the second model when applied to the input dataset is above the threshold, modifying the separating hyperplane such that the first data profile is included in the first profile domain and the second data profile and the input data profile are included in the second profile domain.

13. The non-transitory, computer-readable medium of claim 12, wherein the instructions further cause the one or more processors to perform operations comprising:
based on the similarity metric for the input data profile being highest with respect to the first data profile, processing the input dataset using the first model; and
based on determining that performance of the first model when applied to the input dataset is above the threshold, verifying the separating hyperplane is placed such that the first data profile and the input data profile are included in the first profile domain and the second data profile is included in the second profile domain.

14. The non-transitory, computer-readable medium of claim 12, wherein the instructions further cause the one or more processors to perform operations comprising:
determining that an input attribute from a plurality of attributes included in the input data profile is not represented as a dimension in the first profile domain;
updating the first profile domain and the second profile domain to include a new dimension representing the input attribute; and
updating the separating hyperplane to divide the first profile domain and the second profile domain with respect to the new dimension.

15. The non-transitory, computer-readable medium of claim 12, wherein the instructions for determining the similarity metric for the input data profile with respect to each of the plurality of data profiles further cause the one or more processors to perform operations comprising:
determining a measure of overlap between a plurality of attributes included in the input data profile and a corresponding plurality of attributes included in each of the plurality of data profiles.

16. The non-transitory, computer-readable medium of claim 12, wherein the instructions for verifying the separating hyperplane is placed such that the first data profile and the input data profile are included in the first profile domain and the second data profile is included in the second profile domain further cause the one or more processors to perform operations comprising:
receiving, for the separating hyperplane, a first set of criteria for the first profile domain and a second set of criteria for the second profile domain;
determining that a plurality of attributes for the first data profile and a plurality of attributes for the input data profile satisfy the first set of criteria and do not satisfy the second set of criteria; and
determining that a plurality of attributes for the second data profile satisfy the second set of criteria and do not satisfy the first set of criteria.

17. The non-transitory, computer-readable medium of claim 12, wherein the instructions for determining that performance of the first model when applied to the input dataset is above the threshold further cause the one or more processors to perform operations comprising:
receiving an output dataset from when the first model was applied to the input dataset;
based on comparing the output dataset with a reference dataset, determining an error value; and
determining that a performance metric associated with the error value is above the threshold.

18. The non-transitory, computer-readable medium of claim 12, wherein the instructions further cause the one or more processors to perform operations comprising:
based on determining that the similarity metric for the input data profile with respect to the first data profile is below a similarity threshold and that the similarity metric for the input data profile with respect to the second data profile is below the similarity threshold, calculating a first probability of failure for applying the first model to the input data profile and a second probability of failure for applying the second model to the input data profile; and
based on determining that the first probability of failure is lower than the second probability of failure, processing the input dataset using the first model.

19. The non-transitory, computer-readable medium of claim 12, wherein the instructions further cause the one or more processors to perform operations comprising:
determining that performance of the second model when applied to the input dataset is above the threshold; and
based on determining that performance of the second model when applied to the input dataset is higher than performance of the first model when applied to the input dataset, modifying the separating hyperplane such that the first data profile is included in the first profile domain and the second data profile and the input data profile are included in the second profile domain.

20. The non-transitory, computer-readable medium of claim 12, wherein the instructions further cause the one or more processors to perform operations comprising:
generating a drift parameter for a point on the separating hyperplane; and
in response to determining that the drift parameter changed by more than a threshold drift value, generating a drift warning for display on a user interface associated with a first device.
